(19) United States
(12) Patent Application Publication
(10) Pub. No.: US 2008/0239065 A1
(43) Pub. Date: Oct. 2, 2008

(54) THREE-DIMENSIONAL LIGHT BEAM ACQUISITION APPARATUS

(76) Inventors: Yoshiharu Momonoi, Kanagawa (JP); Masahiro Sekine, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/043,233

(22) Filed: Mar. 6, 2008

(30) Foreign Application Priority Data
Mar. 29, 2007 (JP) 2007-087386

(51) Int. Cl. H04N 13/02

(52) U.S. Cl. 348/49; 348/E13.018

(57) ABSTRACT

A three-dimensional light beam acquisition apparatus includes an imaging optical system and an illumination optical system. The imaging optical system includes a first optical element that allows to pass through light from a subject; a second optical element that is arranged on the optical axis of the first optical element, receives the light from the first optical element, and forms an image corresponding to received light; and an acquiring unit that acquires the image from the second optical element as light beam information. The illumination optical system includes a light source; and a third optical element that collects illumination light from the light source and irradiates the subject with the illumination light through the first optical element.

### CROSS-REFERENCE TO RELATED APPLICATIONS

This application is based upon and claims the benefit of priority from the prior Japanese Patent Application No. 2007-087386, filed on Mar. 29, 2007; the entire contents of which are incorporated herein by reference.

### BACKGROUND OF THE INVENTION

1. Field of the Invention

The present invention relates to a three-dimensional light beam acquisition apparatus that acquires light beam information to be displayed on a three-dimensional image reproduction apparatus.

2. Description of the Related Art

A large number of cameras, moving cameras, and the like are used when acquiring three-dimensional light beam information on objects with depth. Various technologies are known that make it possible to acquire such three-dimensional light beam information. For example, in JP-A H11-008863 (KOKAI), a technology that selectively acquires parallel light beams for scanning is disclosed. In JP-A 2003-307800 (KOKAI), to obtain light beam information of an integral photography system, using a lens array and a relay lens, a technology of erecting an image by using dual optical elements and a relay lens, and enlarging a field angle by scanning is disclosed.

However, conventionally no consideration has been given to the illumination optical system that irradiates a subject with illumination light. Moreover, because the illumination optical system and the imaging optical system, which performs imaging of the subject, are separate, there is a problem of an increased size of an apparatus. Also, because the illumination conditions, such as an illumination angle and color tone, are fixed, there is a problem that imaging can only be performed under predetermined illumination conditions.

### SUMMARY OF THE INVENTION

According to an aspect of the present invention, there is provided a three-dimensional light beam acquisition apparatus including an imaging optical system and an illumination optical system. The imaging optical system includes a first optical element that allows to pass through light from a subject; a second optical element that is arranged on the optical axis of the first optical element, receives the light from the first optical element, and forms an image corresponding to received light; and an acquiring unit that acquires the image from the second optical element as light beam information. The illumination optical system includes a light source; and a third optical element that collects illumination light from the light source and irradiates the subject with the illumination light through the first optical element.

### BRIEF DESCRIPTION OF THE DRAWINGS

FIG. 1 is a schematic diagram of a three-dimensional image reproduction apparatus according to a first embodiment of the present invention;

FIG. 2 is a schematic diagram for explaining three-dimensional image reproduction by the three-dimensional image reproduction apparatus;

FIG. 3 is a schematic diagram of a three-dimensional image reproduction apparatus according to a second embodiment of the present invention;

FIG. 4 is a schematic front view of a slit array plate shown in FIG. 3;

FIG. 5 is a plan view of an imaging optical system in a three-dimensional light beam acquisition apparatus according to a third embodiment of the present invention;

FIG. 6 is a side elevation view of the imaging optical system shown in FIG. 5;

FIG. 7 is a side elevation view of the imaging optical system shown in FIG. 5;

FIG. 8 is a plan view of the imaging optical system shown in FIG. 5;

FIG. 9 is a schematic diagram for explaining a relationship between illumination light and light from a subject;

FIG. 10 is a schematic diagram for explaining an alternative relationship between illumination light and light from a subject;

FIG. 11 is a schematic diagram for explaining an alternative relationship between illumination light and light from a subject;

FIG. 12 is a schematic diagram for explaining a relationship between an imaging position and an observing position;

FIG. 13 is a schematic diagram of an illumination optical system in a three-dimensional light beam acquisition apparatus according to a fourth embodiment of the present invention;

FIG. 14 is a schematic diagram of an illumination optical system in a three-dimensional light beam acquisition apparatus according to a fifth embodiment of the present invention;

FIG. 15 is a schematic diagram of an illumination optical system in a three-dimensional light beam acquisition apparatus according to a sixth embodiment of the present invention;

FIG. 16 is a schematic diagram for explaining imaging under assumed illumination condition;

FIG. 17 is a schematic diagram for explaining imaging under alternative assumed illumination condition;

FIG. 18A is a schematic diagram for explaining a relationship between an illumination range and an imaging range of a two-directional-type three-dimensional light beam acquisition apparatus, FIG. 18B is an example of an illuminated image, FIG. 18C is an illuminated image in the imaging range shown in FIG. 18A, and FIG. 18D is an example of light beam information acquired from an illuminated image in the imaging range shown in FIG. 18A;

FIG. 19A is a schematic diagram for explaining a relationship between an illumination range and an imaging range of a one-directional-type three-dimensional light beam acquisition apparatus, FIG. 19B is an example of an illuminated image, FIG. 19C is an illuminated image in the imaging range shown in FIG. 19A, and FIG. 19D is an example of light beam information acquired from an illuminated image in the imaging range shown in FIG. 19A;

FIG. 20 is a schematic diagram of an imaging optical system in a three-dimensional light beam acquisition apparatus according to a seventh embodiment of the present invention;

FIG. 21A is a top view of an imaging optical system of a two-directional-type three-dimensional light beam acquisition apparatus according to an eighth embodiment of the present invention, and FIG. 21B is a front view of the imaging optical system shown in FIG. 21A;

FIG. 22A is a side elevation view of an imaging optical system of a one-directional-type three-dimensional light beam acquisition apparatus according to a ninth embodiment of the present invention, FIG. 22B is a top view of the imaging optical system shown in FIG. 22A, and FIG. 22C is a front view of the imaging optical system shown in FIG. 22A;

FIG. 23 is a schematic diagram of an imaging optical system in a three-dimensional light beam acquisition apparatus according to a thirteenth embodiment of the present invention;

FIG. 24 is a schematic diagram of an imaging optical system in a three-dimensional light beam acquisition apparatus according to an eleventh embodiment of the present invention;

FIG. 25 is a schematic diagram of an imaging optical system in a three-dimensional light beam acquisition apparatus according to a twelfth embodiment of the present invention;

FIG. 26 is a schematic diagram of an imaging optical system in a three-dimensional light beam acquisition apparatus according to a thirteenth embodiment of the present invention;

FIG. 27A is a schematic diagram of a two-dimensional lens array that can be used as a lens, and FIG. 27B is a schematic diagram of another two-dimensional lens array that can be used as a lens;

FIG. 28 is a schematic diagram of an imaging optical system in a three-dimensional light beam acquisition apparatus according to a fourteenth embodiment of the present invention;

FIG. 29A is a schematic diagram of an illuminated image, and FIG. 29B is a schematic diagram of an image formed at a two-dimensional lens array;

FIG. 30 is a schematic diagram of an imaging optical system in a three-dimensional light beam acquisition apparatus according to a fifteenth embodiment of the present invention;

FIG. 31 is a schematic diagram of an imaging optical system in a three-dimensional light beam acquisition apparatus according to a sixteenth embodiment of the present invention;

FIG. 32A is a schematic diagram of an illuminated image, and FIG. 32B is a schematic diagram of an image formed at the two-dimensional lens array;

FIG. 33 is a schematic diagram for explaining the optical characteristics of a lens L23 shown in FIG. 31;

FIG. 34 is a schematic diagram for explaining the optical characteristics of a lens L43 shown in FIG. 31;

FIG. 35 is a schematic diagram for explaining the optical characteristics of a two-dimensional lens array L42 shown in FIG. 31; and

FIG. 36 is a schematic diagram for explaining the optical characteristics of a two-dimensional lens array L21 shown in FIG. 31.

### DETAILED DESCRIPTION OF THE INVENTION

Exemplary embodiments of the present invention will be explained in detail below with reference to the accompanying drawings.

A three-dimensional light beam acquisition apparatus is an apparatus that acquires three-dimensional light beam information required for reproduction of a three-dimensional image using a three-dimensional image reproduction apparatus.

Before explaining various embodiments of a three-dimensional light beam acquisition apparatus, various embodiments of a three-dimensional image reproduction apparatus will be explained first.

(A) Three-Dimensional Image Reproduction Apparatus

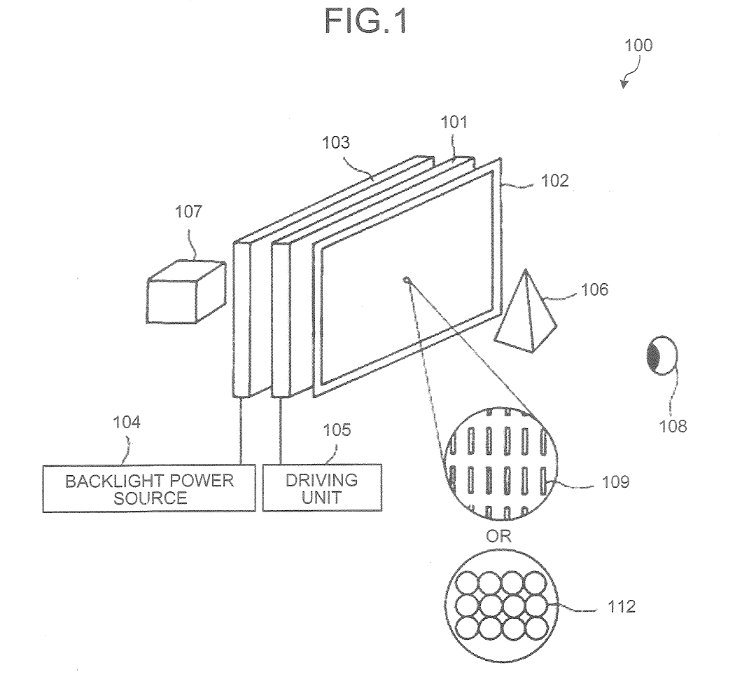

A three-dimensional image reproduction apparatus 100 that can display a three-dimensional image will be explained with reference to FIGS. 1 through 4.

(1) Outline of Three-Dimensional Image Reproduction Apparatus

FIG. 1 is a schematic diagram of the three-dimensional image reproduction apparatus 100. A liquid crystal display 101 includes a color liquid crystal display screen in which sub-pixels of three primary colors of red, green, and blue (RGB) are arranged in a planar matrix as described below. The liquid crystal display 101 is electrically driven by a driving unit 105 and parallax information is displayed on each row of the display screen. A backlight 103 is arranged at a rear side of the liquid crystal display 101. Light emitted from the backlight 103 illuminates the display screen of the liquid crystal display 101, by driving power supplied from a backlight power source 104.

A pinhole array plate 102 that is used as a light beam control element is arranged opposite to the backlight 103, that is, at a position between the display screen of the liquid crystal display 101 and an observer 108. A three-dimensional real image 106 is reproduced by a light beam group emitted from each pinhole 109 of the pinhole array plate 102, and recognized by the observer 108.

By tracking the light beam from the pinhole array plate 102 in a direction opposite to the three-dimensional real image 106, a three-dimensional virtual image 107 can be reproduced. Further, three-dimensional images can be reproduced continuously at front and rear of the pinhole array plate 102. A known microlens array 112 may be used instead of the pinhole array plate 102.

(2) Configuration of Three-Dimensional Image Reproduction Apparatus

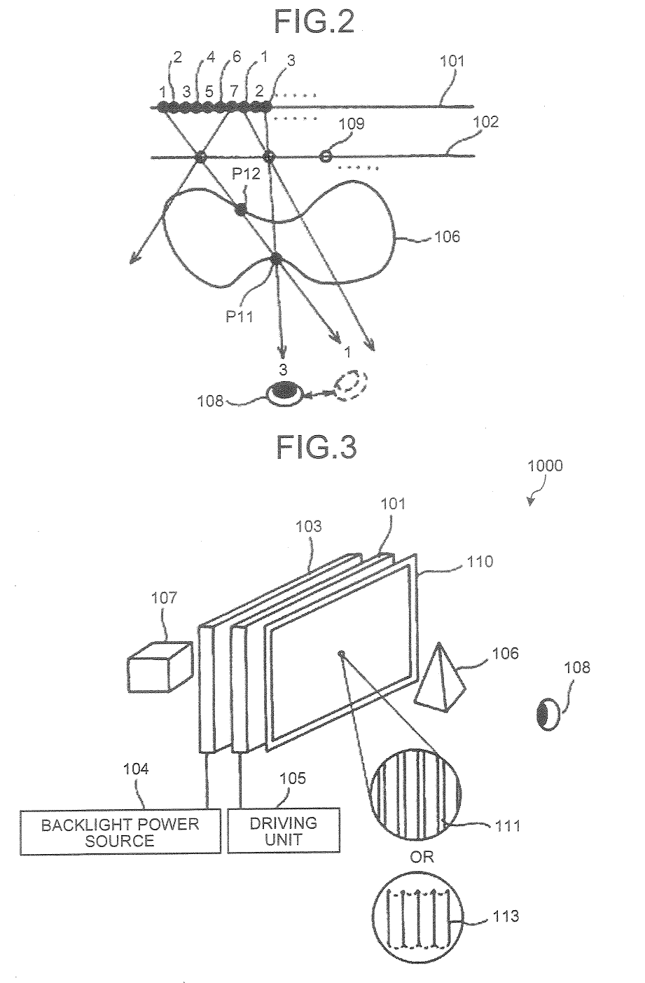

The three-dimensional image reproduction apparatus 100 is configured as follows, so as a natural and highly precise three-dimensional image without color breakup, which is caused by mixing of RGB colors, can be reproduced. FIG. 2 is a schematic diagram for explaining a positional relationship between the three-dimensional image reproduction apparatus 100 and the three-dimensional real image 106, when viewed from top. Because the liquid crystal display 101 is positioned behind the pinhole array plate 102 with respect to the observer 108, it displays a parallax image group containing images that look slightly different to the observer 108 depending on angle of view of the observer 108. In other words, the liquid crystal display 101 displays a multiple-viewpoint image. When the light emitted from the multiple-viewpoint image passes through the pinholes 109, it is output through the pinholes 109 as a number of groups of parallax image light beams. The three-dimensional real image 106 is reproduced when those groups of parallax image light beams are collected.

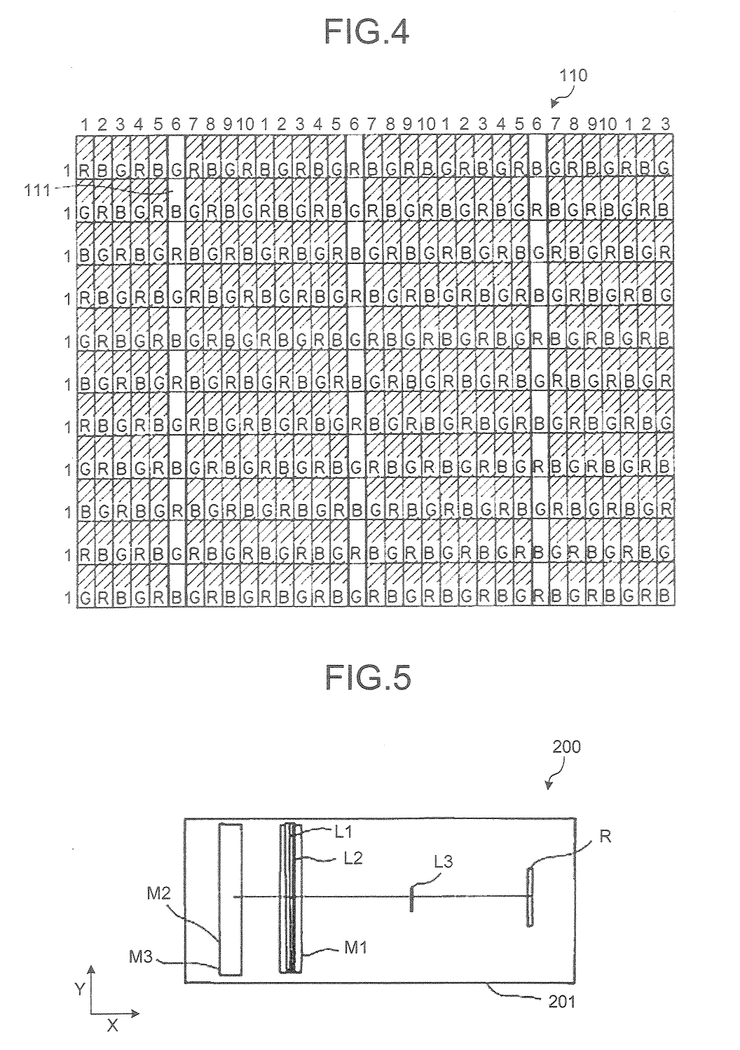

In the liquid crystal display 101, which displays the multi-viewpoint image two-dimensionally, the smallest drive unit is a sub-pixel of red (R), green (G), and blue (B) (see FIG. 4). Composite colors can be reproduced by using the three sub-pixels of R, G, and B. Each sub-pixel displays information on luminance and color at a point (display point) where a straight line that passes through the center of the pinhole 109 from the respective sub-pixels intersects with a three-dimensional image on a display space. The point where the straight line from the same sub-pixel that passes through the same pinhole 109 intersects with the three-dimensional image exists plurally. The closest point to the observer is the display point. For example, in FIG. 2, a point P11 that is closer to the observer 108 than P12 is the display point.

(3) Other Embodiments of Three-Dimensional Image Reproduction Apparatus

FIG. 3 is a schematic diagram of a three-dimensional image reproduction apparatus 1000 according to a second embodiment of the present invention. In the three-dimensional image reproduction apparatus 1000, a slit array plate 110 is arranged instead of the pinhole array plate 102 shown in FIG. 1. The slit array plate 110 has a plurality of openings, or slits 111, that extend in a vertical direction or a horizontal direction. FIG. 4 is a schematic view of the slit array plate 110 when viewed from front.

When the slit array plate 110 is used as the light beam control element, parallax in the vertical direction is ignored, because a refractive index in the vertical direction is negligibly small. The slit array plate 110 is advantageous in that it can be manufactured easily than the pinhole array plate 102. Moreover, the slit array plate 110 can reproduce a natural and highly precise three-dimensional image without color separation as the pinhole array plate 102. Instead of the slit array plate 110, a lenticular sheet 113 that includes a plurality of cylindrical lenses having curvature in the horizontal direction or the vertical direction can be used.

(B) Theory of Three-Dimensional Light Beam Acquisition Apparatus

In the three-dimensional image reproduction apparatus 100 (or 1000), the light-beam information is reproduced by displaying pixels that are located at positions defined by the light beam information to the rear side of the pinhole array plate 102. To perform such a display, it is necessary to acquire light beam information corresponding to the configuration of the three-dimensional image reproduction apparatus 100 (or 1000), in particular, optical characteristics of the light beam control element.

In this regard, a three-dimensional light beam acquisition apparatus 200 (see FIG. 5) acquires light beam information corresponding to the configuration of the three-dimensional image reproduction apparatus 100 (or 1000), by adopting one of the configurations shown in FIGS. 7 and 8. Specifically, a lens L1 corresponds to the light beam control element in the three-dimensional image reproduction apparatus 100 (or 1000) and converts a light beam angle from a subject to a position on a lens L2. An image forming lens L3 forms an image in a direction without parallax as a transparent image, and serves to acquire the light beam information in a direction with parallax on the lens L2. The light beam information includes reflected light, transmitted light, and self-emitting light.

(C) Three-Dimensional Light Beam Acquisition Apparatus

Embodiments of a three-dimensional light beam acquisition apparatus will now be explained with reference to the accompanying drawings.

The three-dimensional light beam acquisition apparatus 200 will be explained with reference to FIGS. 5 through 8.

(1) Configuration of Three-Dimensional Light Beam Acquisition Apparatus 200

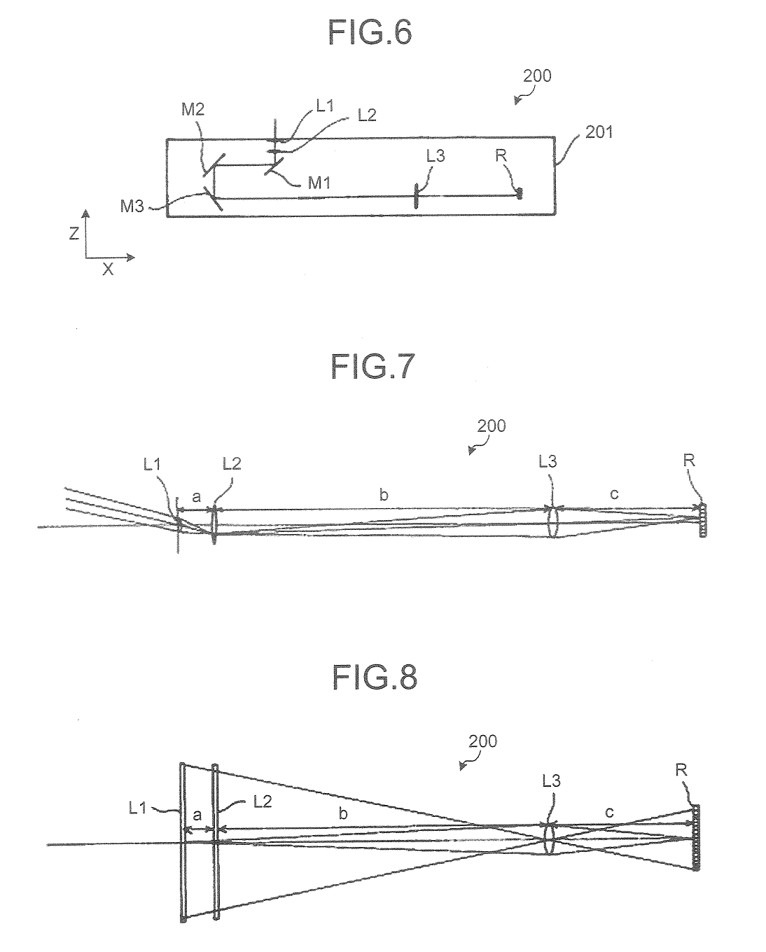

The three-dimensional light beam acquisition apparatus 200 includes an optical system used for imaging and illumination, a drive system that drives the optical system so as to perform scanning, and an acquiring unit that acquires (images) image data with each drive. FIG. 5 is a plan view of the three-dimensional light beam acquisition apparatus 200. FIG. 6 is a side elevation view of the three-dimensional light beam acquisition apparatus 200. In FIGS. 5 and 6, only the optical system (hereinafter, “imaging optical system”) and an acquiring unit R used in imaging within a casing 201 are shown.

As shown in FIGS. 5 and 6, the imaging optical system in the three-dimensional light beam acquisition apparatus 200 includes the lens L1, the lens L2, the image forming lens L3, a mirror M1, a mirror M2, and a mirror M3. The mirror M1 bends an optical axis that passes through the lens to 90 degrees. The mirrors M2 and M3 receive the light from the mirror M1, and reflect the light to the image forming lens L3. The acquiring unit R that acquires the light beam information is arranged at a subsequent stage of the image forming lens L3. An acquiring unit such as a CCD or a CMOS sensor can be used as the acquiring unit R.

(2) Definition of Rectangular Coordinate System

In a rectangular coordinate system that represents the light beam information, a horizontal direction (a plane parallel to a paper surface in FIG. 6) of a plan view (FIG. 5) is called a horizontal direction (a plane formed by an x-axis and a y-axis). A vertical direction (a direction vertical to the paper surface in FIG. 6) of the plan view is called a vertical direction (a z-axis direction). In the x, y, z coordinate system, the acquiring unit R that can image a two-dimensional image such as the lens L1, the lens L2, the CCD, and the CMOS is extended in the y-axis direction. A scanning direction of the acquiring unit R is the x-axis direction.

(3) Operation of Three-Dimensional Light Beam Acquisition Apparatus 200

The lens L1, the lens L2, and the mirror M1 move integrally in the x-axis direction. The mirror M2 and the mirror M3 are formed integrally, and they move in the x-axis direction at half the traveling speed of the traveling speed of the lens L1, the lens L2, and the mirror M1. In this manner, an optical path length from the lens L1 does not change even during the scanning operation. The mirror M1, the mirror M2, and the mirror M3 have shapes that cover an image acquisition range through the lenses.

(4) Principle of Three-Dimensional Light Beam Acquisition Apparatus 200

FIGS. 7 and 8 are schematic diagrams that show the light beam of the imaging optical system shown in FIG. 5 as a straight line. Reflection of the light beam by the mirrors M1, M2, and M3 has been not considered in FIGS. 7 and 8. FIG. 7 is a side elevation view of the three-dimensional light beam acquisition apparatus 200. FIG. 8 is a plan view of the three-dimensional light beam acquisition apparatus 200.

In FIGS. 7 and 8, a distance “a” is a distance between the lens L1 and the lens L2. A distance “b” is a distance between the lens L2 and the image forming lens L3. A distance “c” is a distance between the image forming lens L3 and the acquiring unit R.

A focal length f1 of the lens L1 is equal to the distance “a”. A focal length f2 of the lens L2 is −1/f2=1/a−1/b. In the image forming lens L3, when a focal length f3h in the horizontal direction and a focal length f3v in the vertical direction are different, the focal length f3h in the horizontal direction can be calculated by using Equation (1). Moreover, the focal length f3v in the vertical direction can be calculated by using Equation (2). Interposing the lenses L1, L2, and L3 therebetween, a side of an image (right side of FIGS. 7 and 8) is positive (+), and a side of an object that is a subject (left side of FIGS. 7 and 8) is negative (−).

Horizontal direction: 1/(a+b)−1/c=−1/f3h (1)

Vertical direction: 1/b−1/c=−1/f3v (2)

In the horizontal direction, the lens L1 collects parallel light from the subject with a lens width, and the light collected on the lens L2 forms an image on the acquiring unit R by the image forming lens L3 via the lens L2. In the vertical direction, an image (including a certain depth of field) on a lens surface (scanning surface) of the lens L1 is formed on the acquiring unit R.

By forming the imaging optical system as the above, a parallax of the subject can be acquired as many as a number of pixels of the acquiring unit R in the angular distribution of the parallel light at the surface of the lens L1. By arranging the lens L2 between the lens L1 and the image forming lens L3, a wide angle range can be achieved on the acquiring unit R. In the vertical direction, an image of the subject can be formed without parallax. An image of the subject in the horizontal direction can be acquired by scanning. The image that is scanned and imaged at the acquiring unit R is stored in a memory (not shown).

A slit (or a pinhole) may be used instead of the lens L1. When a slit (or a pinhole) is used, the size of the slit (or a pinhole) preferably corresponds to the optical characteristics of the slit array plate 110 (or the pinhole array plate 102) of the three-dimensional image reproduction apparatus 100 (or 1000). When the lens L1 and the image forming lens L3 are in a conjugate image relationship by the lens L2, the same effect can be acquired by forming the image forming lens L3 into a slit. By adopting a telecentric optical system to the image forming lens L3, the slit is arranged at a focal position of the image forming lens L3, and the relationship between the slit and the lens L1 is made in the conjugate image relationship by the lens L2, thereby enabling to acquire the same effect.

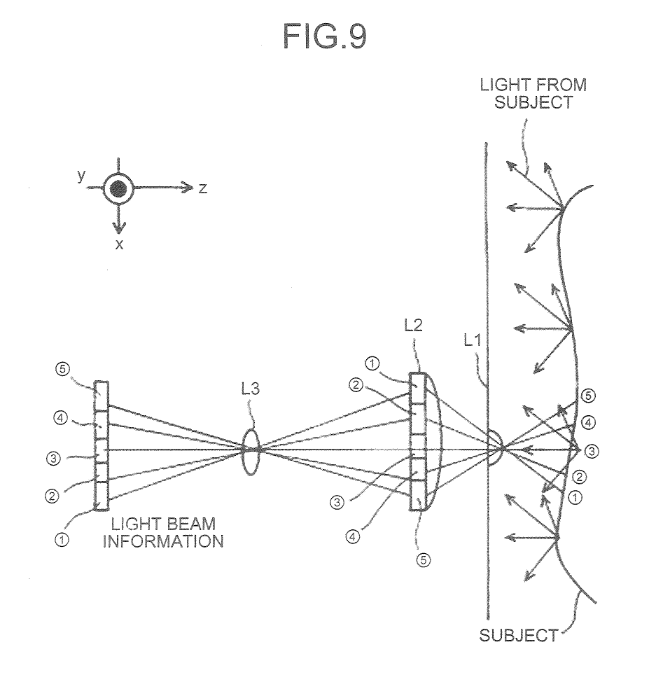

A relationship between illumination light and light from the subject will now be explained with reference to FIGS. 9 through 12.

FIG. 9 is a side elevation view of the imaging optical system including a subject. The reflecting of light beam by the mirrors M1 through M3 is omitted (hereinafter, the same shall apply). The subject scatters and reflects light from illumination in various directions. A three-dimensional image of the subject can be obtained and displayed by acquiring and reproducing the light beam. The light beams from various directions of the subject enter the lens L1. In FIG. 9, as an example, encircled numbers 1 through 5 indicate light beams. By the lens L1, the light beam angles of the encircled numbers 1 through 5 at the position of the lens L1 are collected to different positions on the lens L2. Accordingly, an image is formed on the acquiring unit R by the lens L2 and the image forming lens L3. At this time, an arrangement of the encircled numbers 1 through 5 reverses. Because the arrangement of the encircled numbers 1 through 5 reverses at the lens L1 and also at the image forming lens L3, it reverses twice. Thus, a wide range of the light beam information can be acquired through imaging by changing the position of the lens L1.

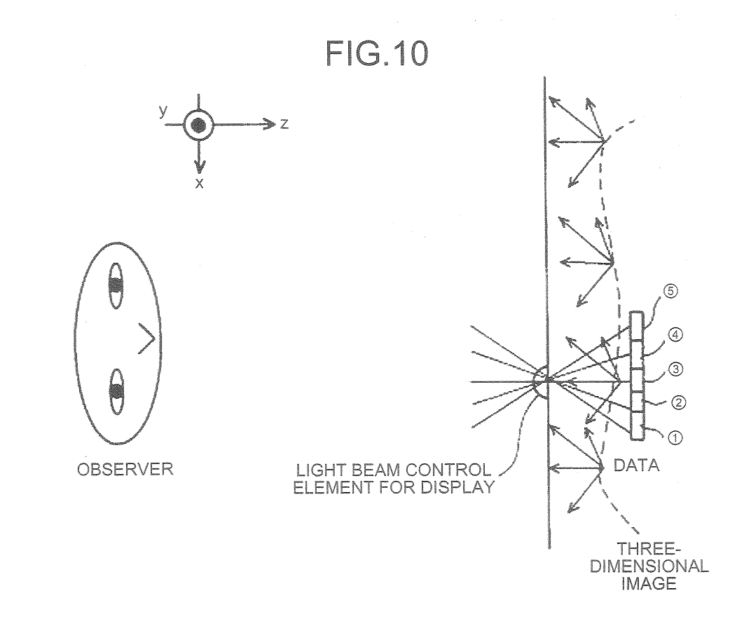

To display the image on the three-dimensional image reproduction apparatus 100 (or 1000), it is necessary that the light beam information corresponding to respective positions is given to the light beam control element such as the lens and the slit corresponding to the lens L1. As shown in FIG. 10, by passing through the light beam control element (such as a lens array, a pinhole array, a lenticular sheet, and a slit array), the pixels at different positions are output corresponding to the light beam angle. In other words, when the light beam information that is being input at the respective positions is displayed, a three-dimensional subject image (three-dimensional image) is reproduced as a convergence of the light beam. For example, when the encircled numbers 1 through 5 that are acquired in FIG. 9 are arranged as in FIG. 10, the exactly same three-dimensional image can be reproduced.

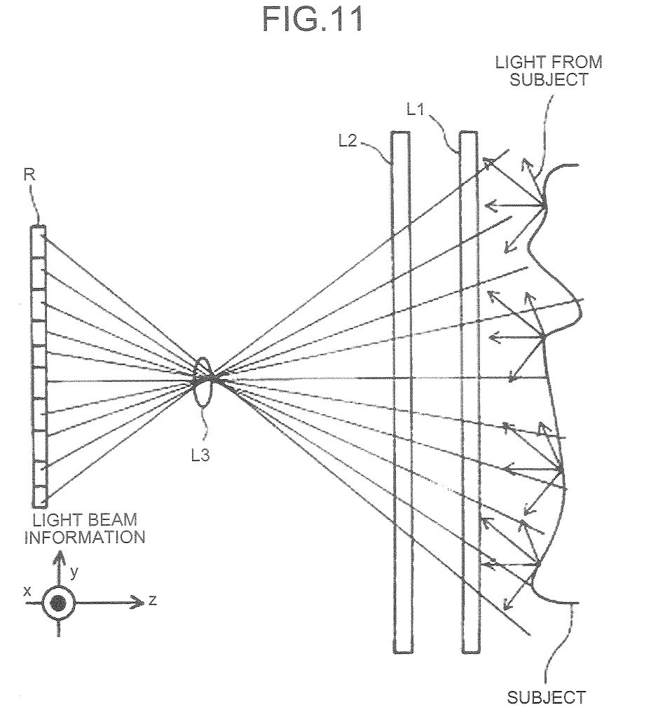

When the parallax in the vertical direction (or horizontal direction) can be ignored, a cylindrical lens having curvature in the horizontal direction (or vertical direction) as shown in the present embodiment is used as the lens L2. In this manner, the lens L2 does not operate in the vertical direction. Therefore, in the vertical direction, as shown in FIG. 11, an image can be acquired in the same way as a general image acquisition.

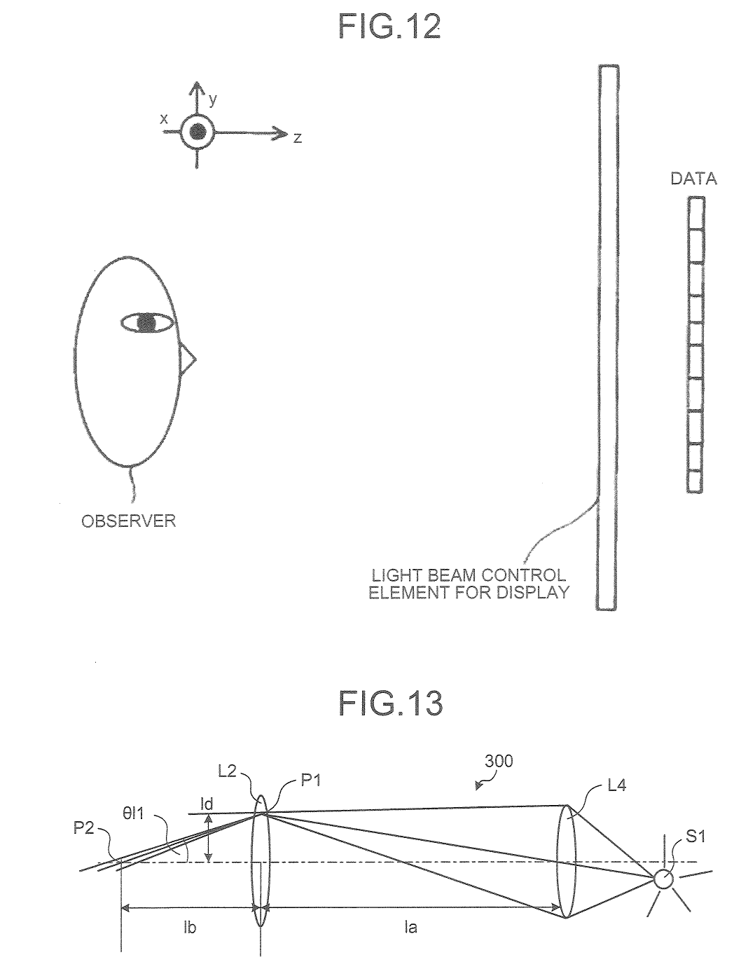

When a three-dimensional image is reproduced using the light beam control element (the lenticular sheet and the slit array) that does not divide parallax in the vertical direction, as shown in FIG. 12, the observer can observe a transparent image from an imaging position in the vertical direction as the general image by observing from the position corresponding to the imaging position of the acquiring unit R. The observer can sense depth by the parallax of both eyes, for example.

In the three-dimensional light beam acquisition apparatus 200, when a uniform illumination is applied to the subject from a narrow range in the casing 201, a shadow may disadvantageously move along the observing position because an illumination direction changes depending on the observing position and the like. To take care of such a disadvantage, in the three-dimensional light beam acquisition apparatus 200, an optical system that includes an optical system for illumination (hereinafter, “illumination optical system”) described below is provided in the casing 201.

(D) Configuration of Illumination Optical System

As described above, in the three-dimensional light beam acquisition apparatus 200, the light beam from the subject is acquired by collecting light from various directions that pass through the lens L2 at the image forming lens L3. Then, the light is projected on the acquiring unit R, and the image is imaged at the acquiring unit R, thereby acquiring the light beam information. If illumination to the subject is considered, the subject can be illuminated from various directions by illuminating so as to track the light beam acquired from the subject backward.

FIG. 13 is a schematic diagram of an illumination optical system 300 that can be used in the three-dimensional light beam acquisition apparatus 200. The illumination optical system 300 includes a projection lens L4 and a light source S1. Further, the lens L2 and the lens L1 (not shown) of the imaging optical system are used in common as the illumination optical system. In the fourth embodiment, the lens L1 is used. However, it is possible to not use the lens L1 but use only the lens L2 in common as the illumination optical system.

The projection lens L4 is an optical element that collects light emitted from the light source S1 to a focusing point P1. When the light from the light source S1 is illuminated by the projection lens L4 so as to be collected on one point on the lens L2, the light bends due to the optical characteristics of the lens L2, thereby illuminating the subject through the lens L1. An angle θ11 is an angle at which the light is bent by the lens L2, a focal length f12 is a focal length of the lens L2, a distance 1d is a distance between the focusing point P1 of the projection lens L4 and the center of the lens L2, and a distance 1a is a distance between the projection lens L4 and the lens L2. Using the above, Equation (3) can be derived. A distance 1b between the position P2 and the lens L2 in Equation (3) can be can be calculated by using Equation (4).

θ11=tan(1d/1b) (3)

1/1b=1/1a−1/f12 (4)

A spread of light is determined by the width of real image and the width of light source of the projection lens L4. In particular, when 1a>>1b, a real image magnification of the projection lens L4 becomes very small (magnification is 1b/1a). Accordingly, when the light source S1 is small, it is possible to illuminate by an intense light beam from one direction.

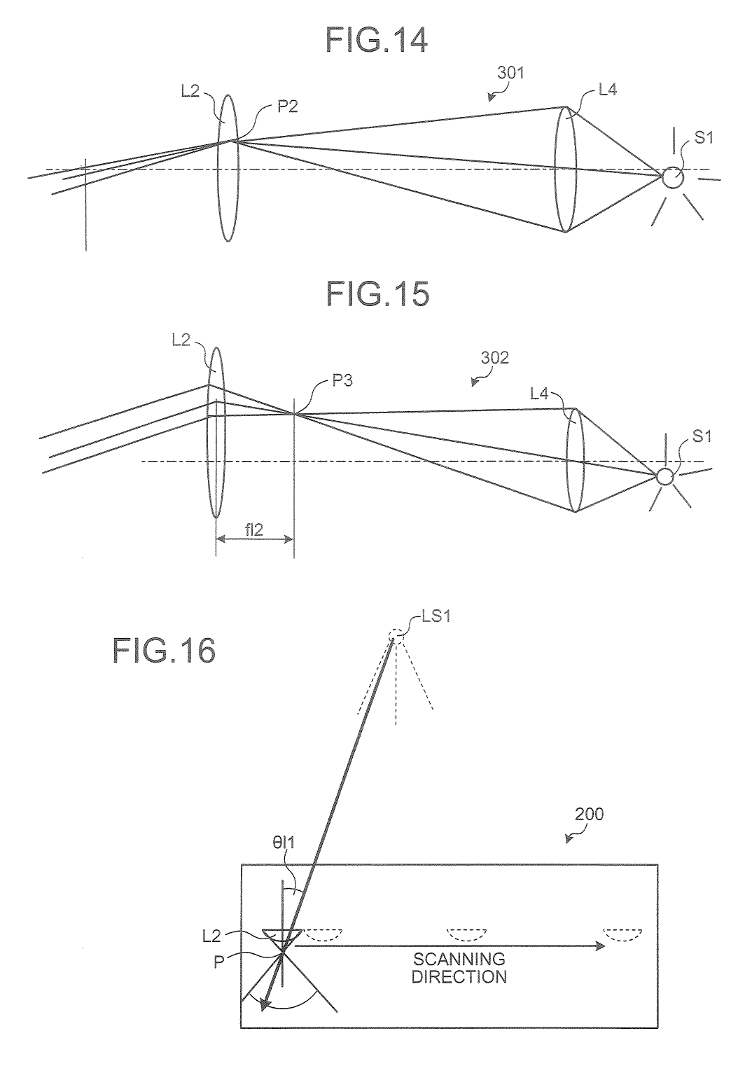

FIG. 14 is a schematic diagram of an illumination optical system 301 according to a fifth embodiment of the present invention. In the illumination optical system 301, a position of the light source S1 is different while the rest of the configuration is the same as that in FIG. 13. When the position of the light source S1 is changed, the focusing point P2 is positioned at a different position from the focusing point P1. In other words, the angle of the illumination light to the subject changes. In this manner, the subject can be illuminated from an arbitrary angle by changing the position of the light source S1.

FIG. 15 is a schematic diagram of an illumination optical system 302 according to a sixth embodiment of the present invention. In the illumination optical system 302, the focusing point P3 of the projection lens L4 is on a focusing surface of the lens L2. The projection lens L4 collects light from the light source S1 to a focusing point P3. If a distance between the focusing point P3 and the lens L2 is equal to the focal length f12 of the lens L2, the illumination light emitted onto the subject is parallel light. The diameter of the light beam emitted onto the subject is determined by the focal length f12, an effective diameter of the projection lens L4, and the like. When the focal length f12 is sufficiently small with respect to the distance 1a between the lens L2 and the projection lens L4, largely reducing the width of the light beam of the parallel light. In other words, the subject can be illuminated by an intense light beam when the focal length f12 is made sufficiently small with respect to the distance 1a.

By using a point light source array as the light source S1, the subject can be illuminated by the intense light beam from an arbitrary angle, by the point light source that is to be lighted. The point light source array is arranged with a plurality of point light sources in the y-axis direction in FIG. 15. In other words, by incorporating the illumination mechanism into the casing 201 of the three-dimensional light beam acquisition apparatus 200, the light beam information when the subject is illuminated from various directions can be acquired. The illumination mechanism is incorporated into the casing 201 by using a half mirror M4 and the like (see FIG. 20, for example) described below. The lens L2 and the lens L1 that serve to acquire the light beam information are used in common in the illumination optical system.

(E) Arbitrary Illumination

(1) Imaging under Assumed Illumination

FIG. 16 is a schematic diagram for explaining imagining under assumed illumination condition. The assumed illumination condition is a state of illumination under a predetermined condition, such as when the subject is illuminated by outside light at a predetermined angle. For example, to reproduce a state that a subject (not shown) is illuminated at an angle of θ11 by light from an assumed light source LS1 as shown in FIG. 16, the light source S1 is located at a position where an angle between a vertical line and a straight line is θ11. The vertical line is a straight line from a reference position P, which is a reference to the imaging, in a direction of the assumed light source LS1. The straight line connects the reference position P and the assumed light source LS1. By changing the imaging position, the angle between the vertical line from the reference position P of the imaging in the direction of the assumed light source LS1, and the straight line that connects the reference position P and the assumed light source LS1 may be changed. Accordingly, a state of the assumed illumination condition can be created.

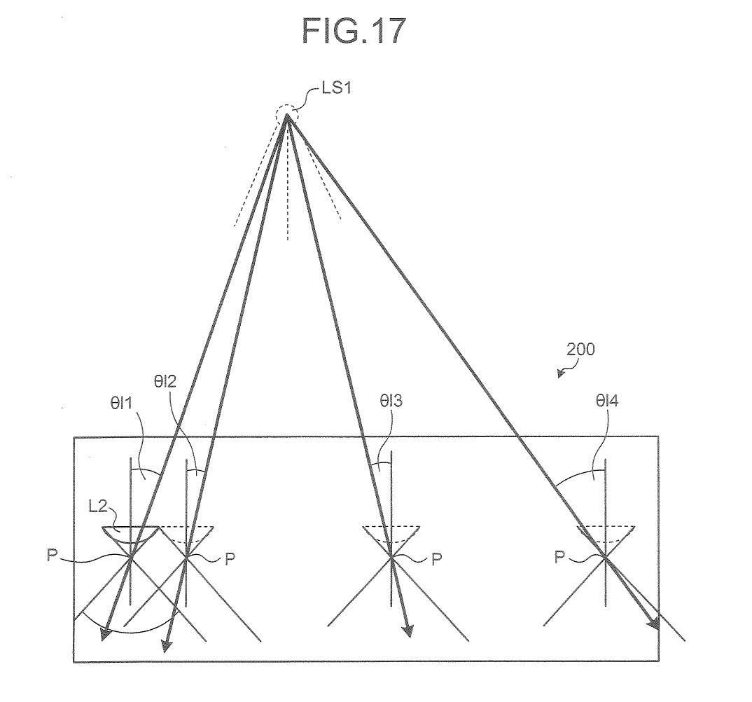

FIG. 17 is a schematic diagram for explaining a relationship between an imaging position and angle fluctuations. As shown in FIG. 17, the angle between the vertical line and the straight line is illuminated with different angles such as θ11, θ12, θ13, and 014 corresponding to the imaging position. The vertical line is the line from the reference position P of the imaging in the direction of the assumed light source LS1. The straight line connects the reference position P and the assumed light source LS1. Accordingly, the illumination state of the assumed light source LS1 can be reproduced.

In the present embodiment, only one light source is assumed. However, illumination due to a plurality of light sources and environmental light (ambient illumination from the surroundings) can be created in the same manner. In particular, the assumed light sources may be reproduced by calculating the light beam by each light source. The illumination may be performed using the calculated illumination as a plurality of light beams. Similarly, the environment light may be reproduced by calculating continuous or discrete illumination conditions of the environment in advance. Then, the illumination may be performed while considering the illumination state (illumination angle, illumination intensity, color tone, and the like) at the scanning position. The illumination conditions mean various conditions related to illumination, for example, a concept including various conditions such as the illumination position (angle), the color tone and the illumination intensity.

(2) Arbitrary Illumination by Post-Processing

In FIGS. 16 and 17, the subject is illuminated under predetermined illumination conditions such as the angle and direction that are assumed in advance. However, the light beam under arbitrary illumination conditions may be reproduced by later post-processing, by performing the illumination under all illumination conditions in the beginning. In particular, after imaging at one point under all illumination conditions that are illuminated, the light beam information under arbitrary conditions can be acquired by combining images using the images only under arbitrary conditions.

For example, the light beam information of the assumed light source, as shown in FIG. 17, may be combined by combining the light beam information imaged at angles such as θ11, θ12, θ13, and θ14 to respective positions. In this manner, when various data on the illumination conditions are acquired in advance, the illumination can correspond to pictures under the momentarily changing illumination conditions, and to the illumination conditions at a position where the display is installed, thereby enabling to express new and realistic pictures.

(3) Direction Dimension of Light Beam to be Acquired and Direction Dimension of Illumination

The three-dimensional light beam acquisition apparatus 200 can be configured in two ways: a two-directional type that acquires parallax in two directions of the horizontal direction and the vertical direction, and a one-directional type that acquires parallax in only one direction out of the two directions of the horizontal direction and the vertical direction. In the two-directional-type three-dimensional light beam acquisition apparatus 200, a microlens array in which concave or convex lenses are arranged in array is used as the lens L2. In the one-directional-type three-dimensional light beam acquisition apparatus 200, a cylindrical lens is used as the lens L2. In the two-directional-type three-dimensional light beam acquisition apparatus 200, a method of acquiring an image by sequentially moving the concave or convex lenses in an x-direction and a y-direction may be used.

To obtain a three-dimensional display, at least the parallax in the horizontal direction is required. Accordingly, at least the three-dimensional display only in the horizontal direction (or vertical direction) can be performed. However, regarding the illumination direction, both the horizontal direction and the vertical direction can be changed by the post-processing, thereby requiring flexibility in the two-dimensional direction. When the lens L2 is used in common in imaging and illumination, the illumination direction can be varied by changing the illumination position (illumination angle) in the horizontal direction, if only the parallax in the one-direction can be imaged (when the cylindrical lens is used as the lens L2).

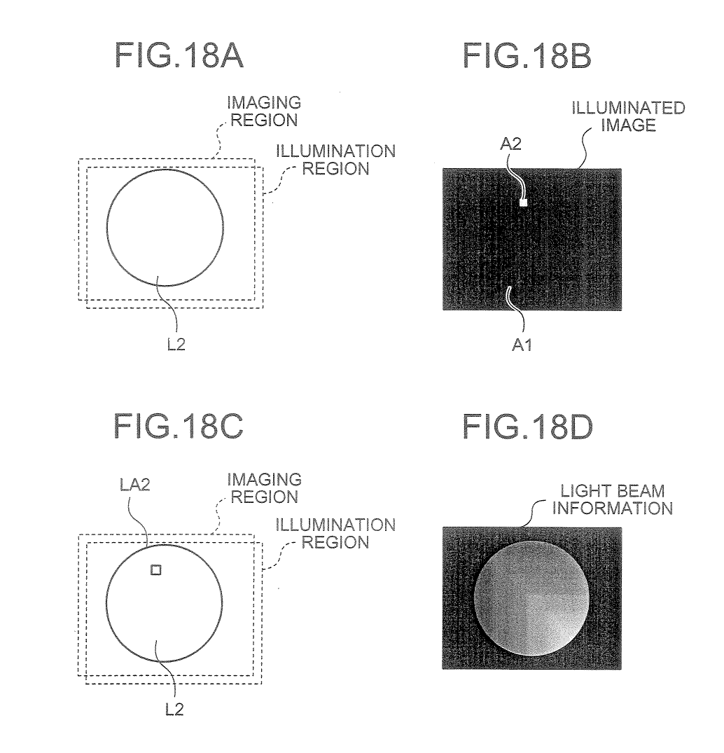

FIG. 18A is a schematic diagram for explaining a relationship between an illumination range and an imaging range of the two-directional-type three-dimensional light beam acquisition apparatus 200, FIG. 18B is an example of an illuminated image, FIG. 18C is an illuminated image in the imaging range shown in FIG. 18A, and FIG. 18D is an example of light beam information acquired from an illuminated image in the imaging range shown in FIG. 18A. A projector S10 described later is used as the light source S1, and the illuminated image projected from the projector S10 is the illumination light.

In FIGS. 18A through 18D, the lens L2 is a convex lens and the like that has a power in both the horizontal direction and the vertical direction. As shown in FIG. 18A, an entire range of a lens surface of the lens L2 can be used for imaging and illumination. Assume that an illuminated image shown in FIG. 18B is projected from the light source onto the lens L2 so as to form an image. The illuminated image in FIG. 18B includes an image region A1 (dark region) that is blacked out with a shading color such as black, and an image region A2 (light region) that is a light spot. As shown in FIG. 18C, the light from the image region A2 forms an image LA2 on the lens L2, and illuminates the subject through the lens L2. The illuminated light is reflected by the subject and imaged on the acquiring unit R as the light beam information as shown in FIG. 18D, by an optical action of the lens L2 and the image forming lens L3. In this example, the respective illumination directions in the x-direction and the y-direction can be controlled, by adjusting the position of the image region A2 that is the light spot.

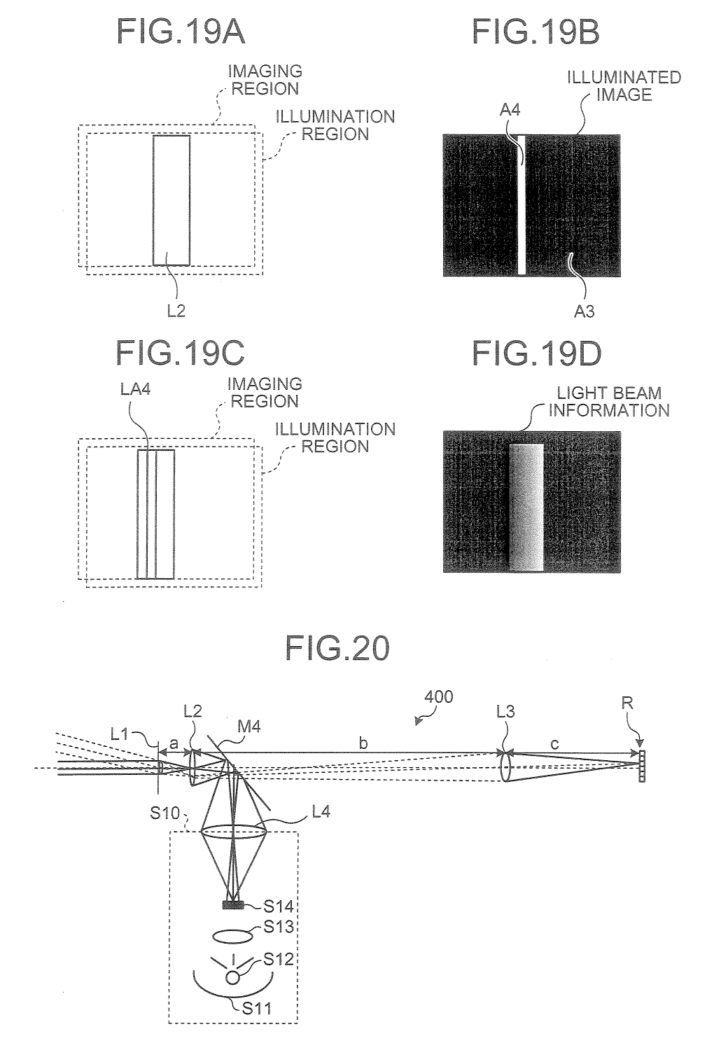

FIG. 19A is a schematic diagram for explaining a relationship between an illumination range and an imaging range of the one-directional-type three-dimensional light beam acquisition apparatus 200, FIG. 19B is an example of an illuminated image, FIG. 19C is an illuminated image in the imaging range shown in FIG. 19A, and FIG. 19D is an example of light beam information acquired from an illuminated image in the imaging range shown in FIG. 19A. If there is no parallax in a one-dimensional light beam direction, a cylindrical lens is used as the lens L2 as described above. In this case, the angle of light beam in the horizontal direction varies by the lens L2, but the angle in the vertical direction does not vary. As shown in FIG. 19A, the entire range of the lens surface of the lens L2 can be used for imaging and illumination. As described in the above, the projector S10 described below is used as the light source S1, and the illuminated image projected from the projector S10 is the illumination light.

In the one-directional-type three-dimensional light beam acquisition apparatus 200, the illumination light is emitted onto a linear (lined) lens surface of the cylindrical lens. Accordingly, as shown in FIG. 19B, the illuminated image that can illuminate vertical linear light is projected. The illuminated image shown in FIG. 19B includes an image region A3 that is blacked out with a shading color such as black, and a vertical linear image region A4 that is the illumination light. As shown in FIG. 19C, the light from the image region A4 forms an image LA4 on the lens L2, and illuminates the subject through the lens L2. The illuminated light is reflected by the subject, and as shown in FIG. 19D, the reflected light is imaged on the acquiring unit R as the light beam information expanded in the horizontal direction, by the optical action of the lens2 and the image forming lens L3.

(F) Illumination System

(1) Projector System

In a projector system, the projector S10 that can project the illuminated image as the illumination light is used in place of the light source S1 shown in FIG. 13. FIG. 20 is a schematic diagram of a three-dimensional light beam acquisition apparatus 400 with a projector system according to a seventh embodiment of the present invention. As shown in FIG. 20, the projector S10 includes a reflector S11, a projector light source S12, a condenser lens S13, an image display element S14, and the like. The image display element S14 is an optically transparent display element such as a liquid crystal display (LCD) panel and a digital mirror device (DMD) that can display image. The light emitted from the projector light source S12 (including the light reflected by the reflector S11) is emitted through the condenser lens S13 and the image display element S14. Accordingly, an image displayed on the image display element S14 is projected as the illuminated image.

At a position where an optical path of the projector S10 and an optical path between the lens L2 and the image forming lens L3 intersects, a half mirror M4 that has a predetermined transmittance (reflectance) is provided. The half mirror M4 reflects the illumination light from the projector S10 and transmits the light from the subject that enters from the lens L2 to the image forming lens L3. In actual, as shown in FIGS. 5 and 6, the imaging is performed by using the mirrors M1 through M3. Accordingly, the projector S10 is installed by attaching to the lens L2 portion.

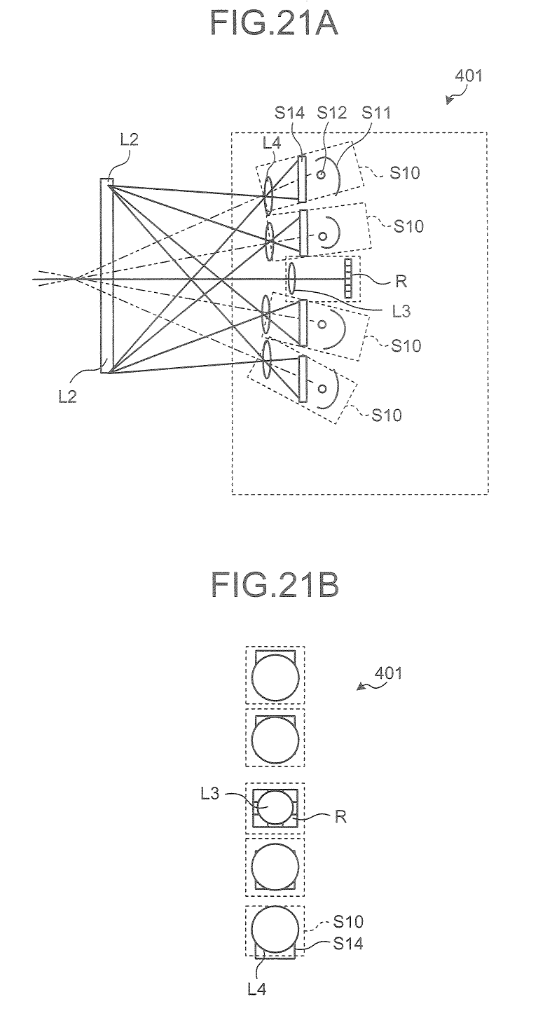

When the half mirror M4 is not used, as shown in FIGS. 21A and 21B, the projector S10 can be installed by attaching to the acquiring unit R. FIG. 21A is a top view of an imaging optical system of a two-directional-type three-dimensional light beam acquisition apparatus 401 with a projector system according to an eighth embodiment of the present invention, and FIG. 21B is a front view of the imaging optical system shown in FIG. 21A. The condenser lens S13 has not been shown in FIGS. 21A and 21B.

In the eighth embodiment, as shown in FIGS. 21A and 21B, to form light beam angles in the horizontal direction, a plurality of projectors S10 are arranged in a direction without parallax around the acquiring unit R, in other words, in the y-axis direction (vertical direction in FIG. 21A). The one that can adjust the illumination angle in the direction without parallax is preferably used as the projector S10. The image display element S14 and the projection lens L4 are preferably installed in parallel with the lens L2. Moreover, an optical axis of each projector light source S12 is preferably focused on one point on the optical axis of the imaging optical system.

(2) Parallel Light Projection Light Source System (LED System)

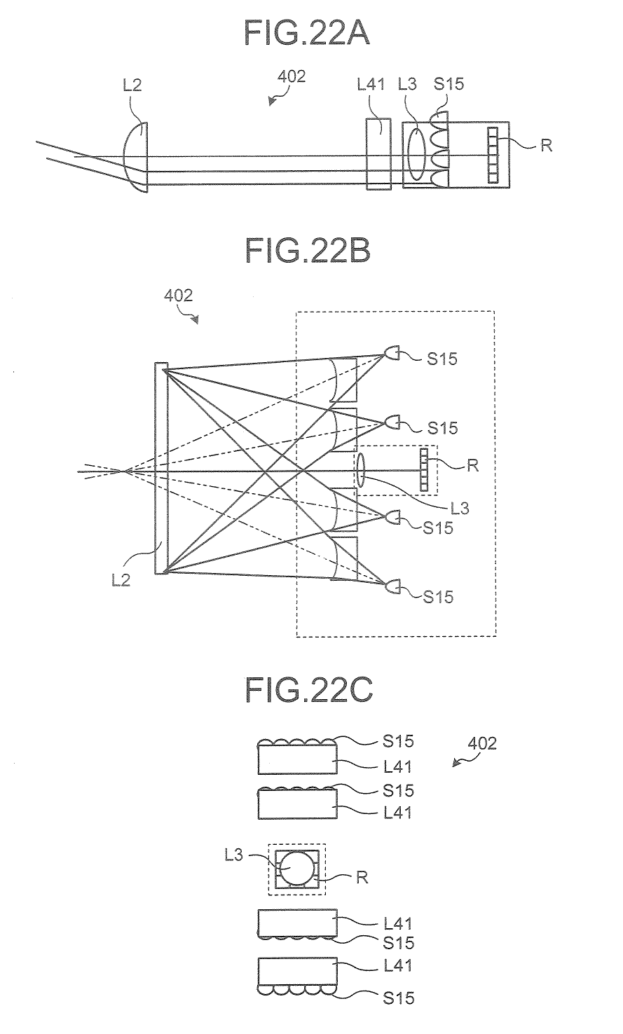

FIG. 22A is a side elevation view of an imaging optical system of a one-directional-type three-dimensional light beam acquisition apparatus 402 with a projector system according to a ninth embodiment of the present invention, FIG. 22B is a top view of the imaging optical system shown in FIG. 22A, and FIG. 22C is a front view of the imaging optical system shown in FIG. 22A. The three-dimensional light beam acquisition apparatus 402 includes a liquid emitting diode (LED) light source S15 that has a directivity close to the parallel light is used as the light source S12.

In the three-dimensional light beam acquisition apparatus 402, a lenticular lens (cylindrical lens), which is used as the lens L1, needs to be illuminated per one line. In this case, a configuration of using a plurality of light sources S1 of the projector, and illuminate respective lines per line by each projector may be considered. However, this leads to a problem of cost increase. Therefore, in the three-dimensional light beam acquisition apparatus 402, the illumination per line will be realized by using a plurality of LED light sources S15, which are cheaper than the projector S10.

In particular, as shown in FIGS. 22A, 22B, and 22C, the same illumination as the projector system can be performed. This is enabled by lining the LED light sources S15 as many as illumination patterns and expands the illumination light from the LED light source on one line of the lens L2, by using a two-dimensional lens array L41 (concave or convex cylindrical lens or the like) as the projection lens L4.

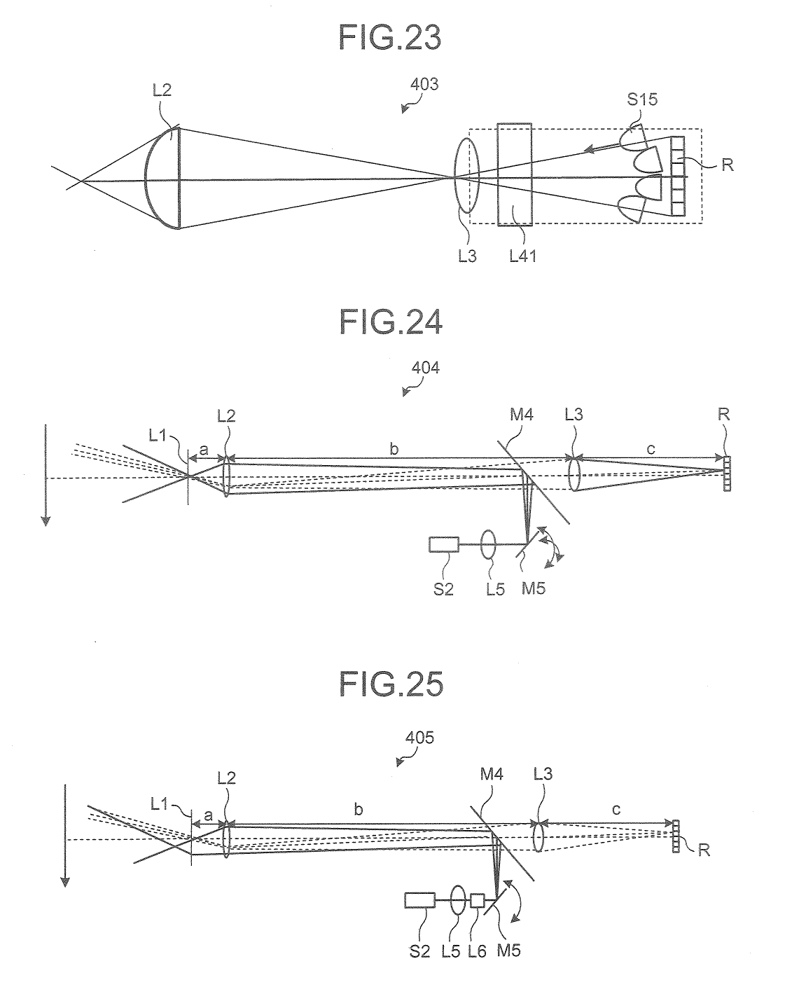

At this time, a focusing point of each cylindrical lens of the two-dimensional lens array L41 is preferably set near the focal length of the lens L2. When the image is retrieved as the parallel light at the acquiring unit R, an alignment between the illumination light and the light beam information may be made easy. Meanwhile, by biasing the directivity of the LED light source S15, an irradiation distance and an irradiation angle to the lens L2 may be made equal. For example, as shown in FIG. 23, in an imaging optical system in a three-dimensional light beam acquisition apparatus 403 according to a tenth embodiment of the present invention, the irradiation distance and the irradiation angle to the surface of the lens L2 can be made equal, by arranging the LED light source in circular arc corresponding to a curved surface of the lens L2.

(3) Mirror System

It is possible to employ a laser light source S2 that can output concentrated light such as a laser beam as the light source S1. In this case, due to the high-intensity illumination, the imaging time can be shortened, thereby enabling to retrieve the image faster. When the laser light source S2 is used, the light beam direction can be controlled faster, by controlling the irradiation position of the illumination light by a mirror that is prepared separately.

FIG. 24 is a schematic diagram of an imaging optical system in a three-dimensional light beam acquisition apparatus 404 according to an eleventh embodiment of the present invention. In the three-dimensional light beam acquisition apparatus 404, a mirror M5 is used for scanning of the illumination light. The mirror M5 provides a rotating support point (not shown). Having the rotating support point in the center, a reflection surface of the mirror M5 is rotatably formed in the x-axis direction (horizontal direction in FIG. 24) and the y-axis direction (vertical direction in FIG. 24) by a driving unit (not shown). The light from the laser light source S2 is reflected at a reflection surface of the mirror M5 through a collimated lens L5, and reaches the lens L2. Also, the surface of the lens L2 (subject) may be scanned by the rotation of the mirror M5.

A polygon mirror, a galvano mirror, a piezo mirror, or the like can be used as the mirror M5. Also, although not “mirror”, equipments that can deflect light such as an acoustooptical deflector (AOD) can be used as the mirror M5. By maintaining a distance from the reflection position of light to the lens L2 of the mirror M5 is equal to a distance from the image forming lens L3 to the lens L2, it is possible to match the reference position of the illumination and the light beam information to be acquired.

In the three-dimensional light beam acquisition apparatus 404, the x-axis direction and the y-axis direction are scanned by using one mirror M5. However, a separate mirror can be used to perform scanning in each of the x-axis direction and the y-axis direction.

FIG. 25 is a schematic diagram of an imaging optical system in a three-dimensional light beam acquisition apparatus 405 according to a twelfth embodiment of the present invention. The three-dimensional light beam acquisition apparatus 405 is a one-directional-type three-dimensional light beam acquisition apparatus in which a cylindrical lens L6 is arranged between the collimated lens L5 and the mirror M5. This makes it possible to control the reflection surface of the mirror M5 only in the y-axis direction. The cylindrical lens L6 expands a laser light flux from the laser light source S2 in the y-axis direction.

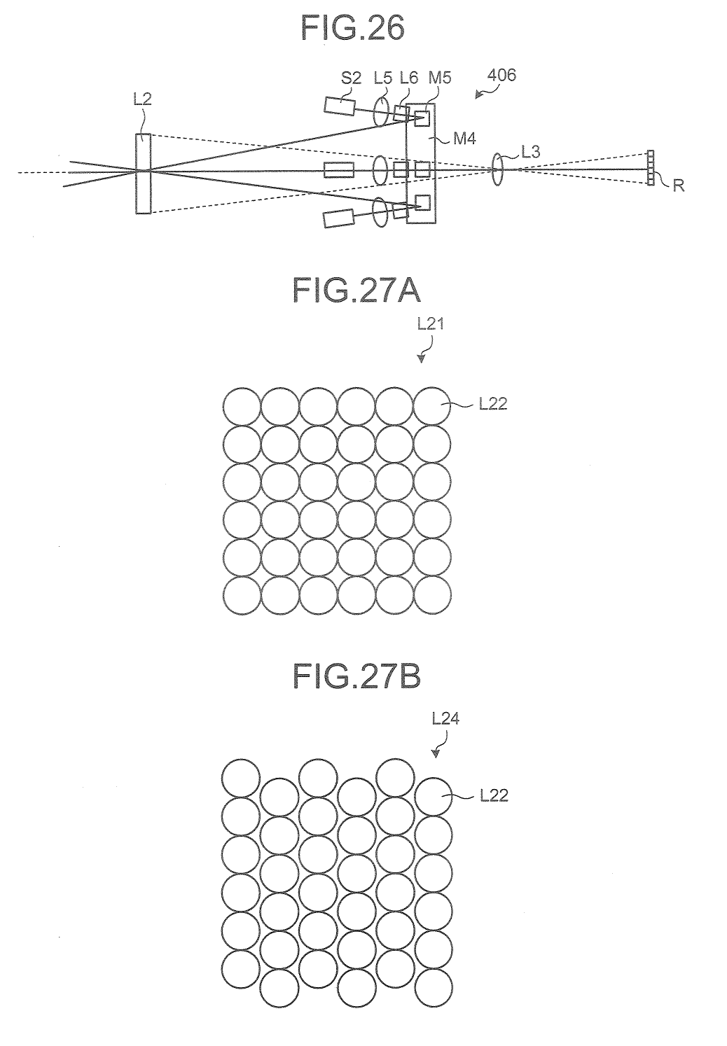

FIG. 26 is a schematic diagram of an imaging optical system in a three-dimensional light beam acquisition apparatus 406 according to a thirteenth embodiment of the present invention. In the three-dimensional light beam acquisition apparatus 406, a plurality of light sources are used. Moreover, a plurality of mirrors M5 that corresponds to the respective plurality of laser light sources S2 are preferably arranged in such a manner that the optical axis of each laser light intersects in the center of the lens L2. With such a configuration, the light beam angle in the horizontal direction and the vertical direction may be controlled by the scanning the mirrors M5. Moreover, as another embodiment, it is possible to change an amount of light of each laser light source S2, depending on the irradiation position to the subject.

(G) Polychromatic Illumination

(1) Filterless Color Imaging with Polychromatic Illumination

In the acquiring unit R of the three-dimensional light beam acquisition apparatus 200, color imaging of the light beam information to be acquired can be realized by using time-multiplexed illumination. The time-multiplexed illumination sequentially emits the illumination light of each RGB color at a predetermined time interval. In this case, a light source that can individually emit the light of respective colors of RGB may be provided as the light source S1. By synchronizing an illumination timing of the light source S1 and an imaging timing by the acquiring unit R, the light beam information of the color image can be acquired. At this time, when the imaging speed is sufficiently fast, high-resolution illumination information can be acquired.

The color imaging of the light beam information using a light source S1 that emits white light may also be realized by irradiating the lens L2 with the light of the light source S1, via a rotating color wheel of RGB. Because the white light includes a spectrum of all the colors, an embodiment that disperses the white light by a prism and the like, and irradiates the lens L2 with the dispersed light of respective colors may be applied. In this case, colors other than the three primary colors of RGB may be used.

(2) Estimation of Spectral Reflectance with Polychromatic Illumination and Image Estimation of Arbitrary Spectrum Illumination

An object (subject) has an inherent reflectance with respect to respective wavelengths of light (spectral reflectance). When the illumination light differs, the light beam information with different color and texture is acquired. Therefore, to reproduce the same color as an original under any illumination light, spectral reflectance data that is inherent to the object with each pixel is required.

Accordingly, when the light beam information is acquired by the three-dimensional light beam acquisition apparatus 200, the subject is irradiated with illuminations with different wavelengths. Accordingly, the spectral reflectance at each wavelength is acquired with each angle. Later, when the illumination light is reproduced under predetermined conditions, the same color and the sense of depth as the original can be acquired, by emitting the illumination light of the spectrum to be reproduced with each angle. The irradiation is performed based on the spectral reflectance at each wavelength that is acquired in advance. Also, by acquiring a plurality of wavelengths from the light emitted from the illumination light with time-multiplex, more accurate spectral reflectance can be acquired.

(H) When Subject is Planar Object (High-Dimensional Texture)

When the light beam information is input, not only a three-dimensional shape can be acquired, but also illumination dimension such as an optical anisotropy of one planar surface can be acquired by transition. While scanning a design (texture) of one planar surface, illumination lights are emitted from the respective directions. Accordingly, the light information of the light emitted surface may be acquired. Also, by using a known image synthesis technique such as a texture mapping, the acquired light beam information may be combined to a three-dimension at a state corresponding to various light beam state.

(I) Imaging Without Scanning Using Two-Dimensional Array

A two-dimensional lens array L21 shown in FIG. 27A or a two-dimensional lens array L24 shown in FIG. 27B can be used as the lens L2. The two-dimensional lens arrays L21 and L24 include a plurality of lenses L22 arranged in a two-dimensional array. When the microlens array 112 is used in the three-dimensional image reproduction apparatus 100, it is preferable to use the one corresponding to the optical characteristics of the two-dimensional lens array L21 or L24.

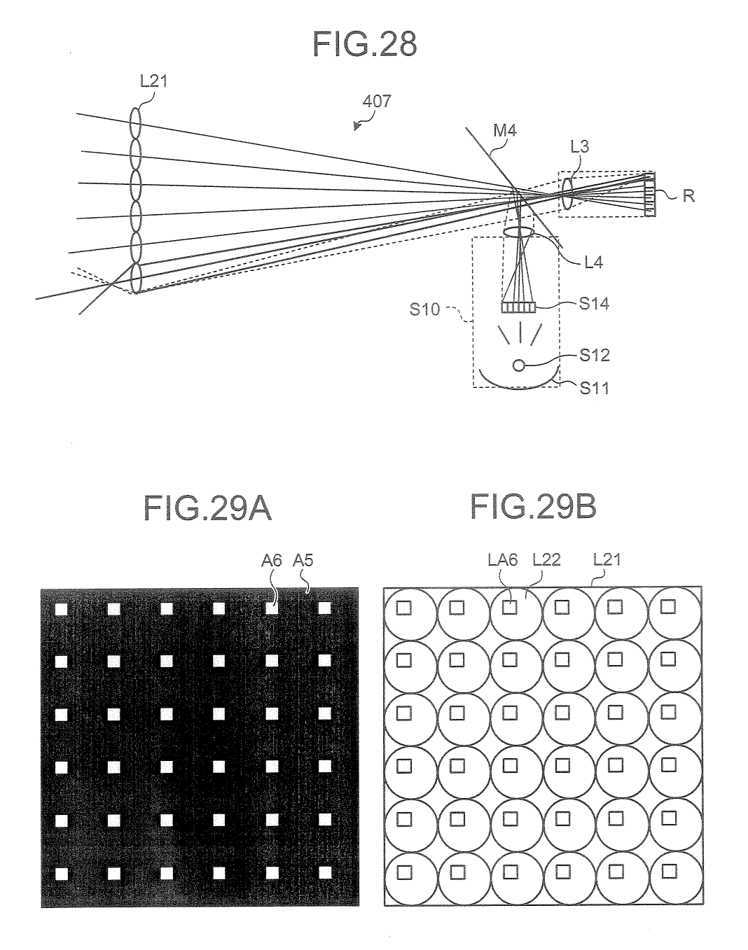

FIG. 28 is a schematic diagram of an imaging optical system in a three-dimensional light beam acquisition apparatus 407 according to a fourteenth embodiment of the present invention. The three-dimensional light beam acquisition apparatus 407 employs the two-dimensional lens array L21 (or L24). When imaging is performed by using the two-dimensional lens array L21, the light beam information acquired through each of the lenses L22 of the two-dimensional lens array L21 is equivalent to the light beam information acquired by imaging from viewpoints different from each other. Accordingly, the light beam information can be acquired without scanning the subject.

In this case, an illuminated image, as shown in FIG. 29A, is projected to each lens of the two-dimensional lens array L21 by the projector S10, as the illuminated image that gives directivity to the illumination light. Accordingly, as shown in FIG. 29B, the illumination light can be irradiated to the same position of the respective lenses L22 of the two-dimensional lens array L21. Thus, the same illumination conditions may be applied to the entire lens L22.

The illuminated image shown in FIG. 29A includes an image region A5 (dark region) that is blacked out with a shading color such as black and an image region A6 (light region) being a light spot at each lens L22. As shown in FIG. 29B, the light from the image region A6 forms an image LA6 on each lens L22 of the two-dimensional lens array L21, and illuminated to the subject through each lens L22. Because of a perspective projection, a misalignment (offset) occurs to the light beam angle, depending on the position of the two-dimensional lens array L21.

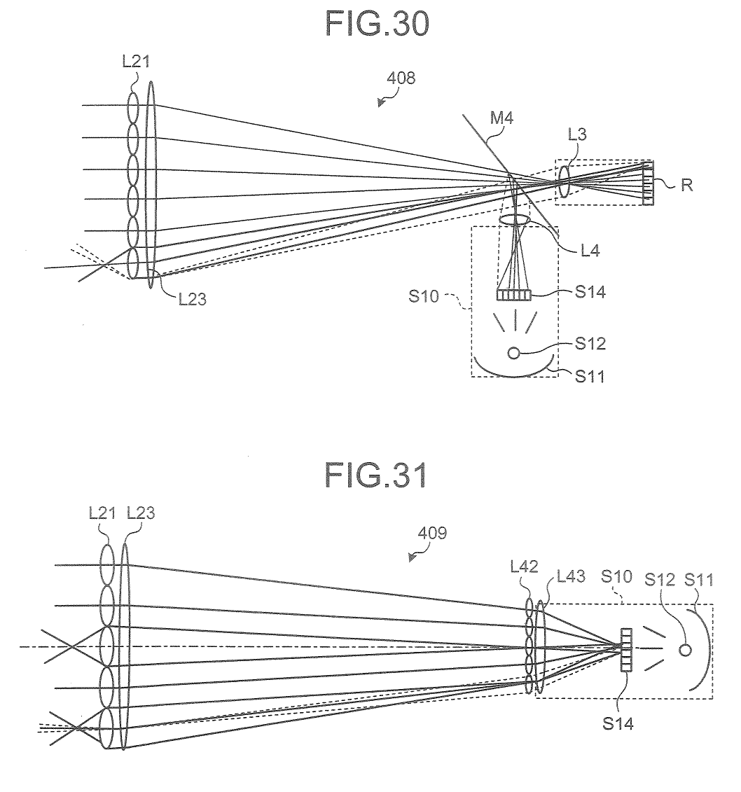

FIG. 30 is a schematic diagram of an imaging optical system in a three-dimensional light beam acquisition apparatus 408 according to a fifteenth embodiment of the present invention. The three-dimensional light beam acquisition apparatus 408 employs the two-dimensional lens array L21 (or L24). To eliminate the offset to the perspective projection of the three-dimensional light beam acquisition apparatus 200 explained in the first embodiment, a lens L23 having the same size as the two-dimensional lens array L21 is arranged. Also, the lens L23 has a focal length equivalent to a distance between the two-dimensional lens array L21 and the projection lens L4 of the illumination system (image forming lens L3 of the imaging system). In this manner, the light is irradiated to the two-dimensional lens array L21 from front, thereby enabling to suppress the offset of the light beam angle caused by different lens positions.

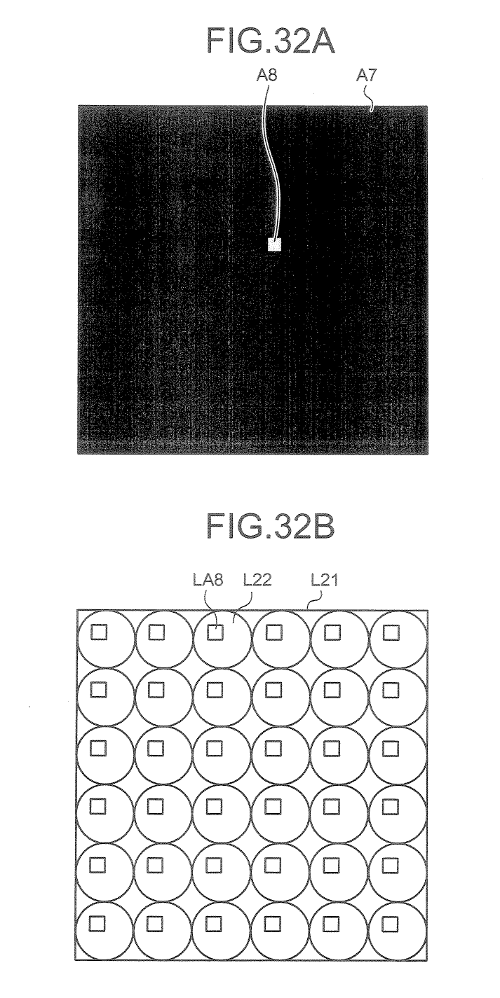

FIG. 31 is a schematic diagram of an imaging optical system in a three-dimensional light beam acquisition apparatus 409 according to a sixteenth embodiment of the present invention. The three-dimensional light beam acquisition apparatus 409 employs the two-dimensional lens array L21. In the three-dimensional light beam acquisition apparatus 409, the half mirror M4 is removed from the configuration of the three-dimensional light beam acquisition apparatus 408 explained in FIG. 30. Moreover, a two-dimensional lens array L42 and a lens L43 are arranged instead of the projection lens L4 of the illumination optical system.

The two-dimensional lens array L42 includes a plurality of lenses having the same number and the same alignment structure as the lenses L22 of the two-dimensional lens array L21 (or L24). In the three-dimensional light beam acquisition apparatus 408, an illuminated image that is emitted from the projector S10 is irradiated to each lens of the two-dimensional lens array L21, by each lens of the two-dimensional lens array L41.

Therefore, a projection image pattern corresponding to the respective lenses L22 of the two-dimensional lens array L21, as shown in FIG. 29A, is not used. Instead, as shown in FIG. 32A, by using one illuminated image corresponding to a predetermined light beam angle, the illumination light, as shown in FIG. 32B, can be irradiated to each lens L22 of the two-dimensional lens array L21. The illuminated image shown in FIG. 32A includes an image region A7 (dark region) that is blacked out with a shading color such as black and an image region A8 (light region) being a light spot at each lens L22. As shown in FIG. 32B, the light from the image region A8 forms an image LA8 on each lens L22 of the two-dimensional lens array L21, and illuminated to the subject through each lens L22, by the optical action of the two-dimensional lens array L42 and the lens L43.

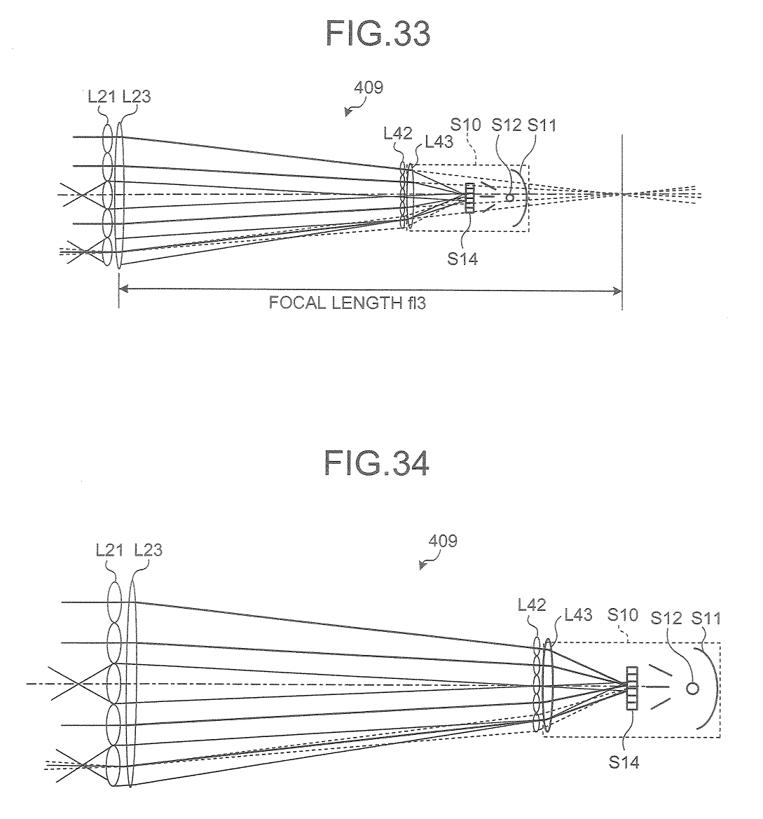

With reference to FIGS. 33 through 36, the illumination optical system of the three-dimensional light beam acquisition apparatus 409 will now be explained in detail. FIG. 33 is a schematic diagram for explaining the optical characteristics of a lens L23 shown in FIG. 32. The lens L23 adjusts the light of illuminated image emitted through the lens L43 and the two-dimensional lens array L42, so as to enter parallel to the two-dimensional lens array L21. In other words, the lens L23 adjusts ratio of an array structure between the two-dimensional lens array L21 and the two-dimensional lens array L42. As shown in FIG. 33, a focal length f13 of the lens L23 is preferably made substantially equal to a distance from the two-dimensional lens array L21 to an intersection of a straight line that connects between a diameter of the two-dimensional lens array L21 and a diameter of the two-dimensional lens array L42.

FIG. 34 is a schematic diagram for explaining the optical characteristics of the lens L43 shown in FIG. 31. The lens L43 is arranged between the two-dimensional lens array L42 and the image display element S14 of the projector S10. The lens L43 is used as a lens that adjusts the ratio of a distance between the image display element S14 and the two-dimensional lens array L42, and a distance between the two-dimensional lens array L42 and the two-dimensional lens array L21.

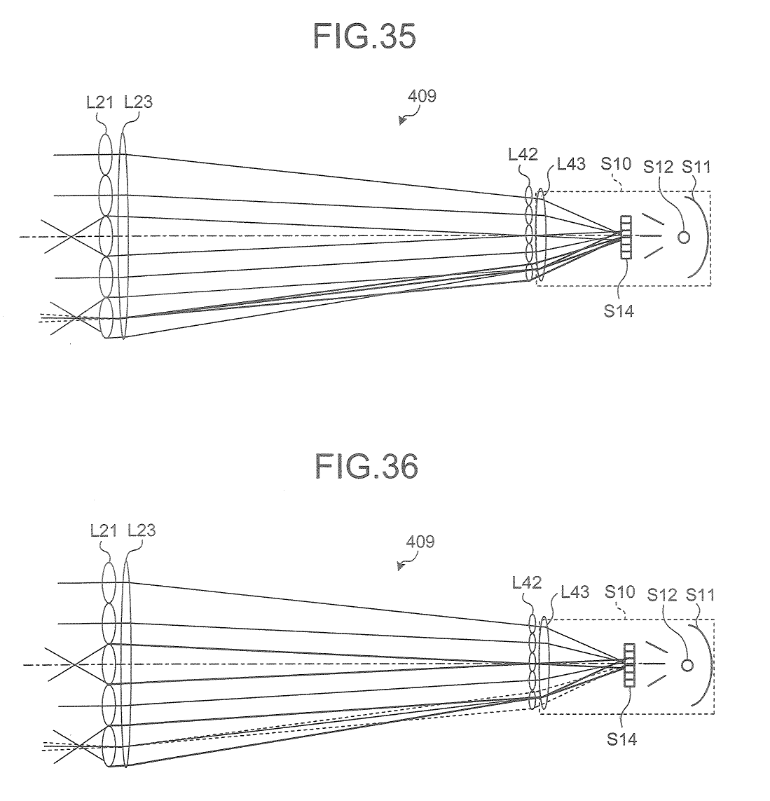

FIG. 35 is a schematic diagram for explaining the optical characteristics of the two-dimensional lens array L42 shown in FIG. 31. Each lens (not shown) included in the two-dimensional lens array L42 forms an image of one point on the image display element S14 on a corresponding lens L22 included in the two-dimensional lens array L21. Accordingly, by setting the same number of lenses included in the two-dimensional lens array L41 as the number of the lenses L22 included in the two-dimensional lens array L21, an image of the image display element S14 can be projected to each lens of the two-dimensional lens array L21. FIG. 36 is a schematic diagram for explaining the optical characteristics of the two-dimensional lens array L21 shown in FIG. 31. As described above, the two-dimensional lens array L21 converts a projection position of the illuminated image to the light beam angle, and illuminates the subject. An arrangement sequence, shape (concave or convex), and the like of the two-dimensional lens array L21, the lens L23, the two-dimensional lens array L42, and the lens L43 can be changed depending on usage environment.

As described above, in the three-dimensional light beam acquisition apparatus 409, a first optical element that is included in the imaging optical system is used in common in the illumination optical system that irradiates the subject with illumination light. As a result, light beam information under predetermined illumination conditions can be acquired with a space-saving configuration.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A three-dimensional light beam acquisition apparatus comprising:
an imaging optical system that includes
a first optical element that allows light to pass through from a subject;
a second optical element that is arranged on the optical axis of the first optical element, receives the light from the first optical element, and forms an image corresponding to received light; and
an acquiring unit that acquires the image from the second optical element as light beam information; and
an illumination optical system that includes
a light source; and
a third optical element that collects illumination light from the light source and irradiates the subject with the illumination light through the first optical element.

2. The apparatus according to claim 1, wherein
the illumination optical system further includes a half mirror that reflects the illumination light from the third optical element to the first optical element and transmits the light from the first optical element to the second optical element, and
the half mirror is provided at a position where an optical path of the light source and an optical path between the first optical element and the second optical element intersect.

3. The apparatus according to claim 1, wherein the third optical element has a focusing point that is positioned on the first optical element.

4. The apparatus according to claim 1, wherein a focusing point of the third optical element coincides with a focusing point of the first optical element.

5. The apparatus according to claim 1, wherein the light source is an image projecting unit that projects an illuminated image as the illumination light.

6. The apparatus according to claim 5, wherein the illuminated image includes a light region being an illumination light portion and a dark region being a shading portion.

7. The apparatus according to claim 1, wherein the first optical element is a cylindrical lens.

8. The apparatus according to claim 1, wherein the first optical element is a first lens array that a plurality of lenses are arranged in array.

9. The apparatus according to claim 8, wherein
the third optical element is a second lens array in which a plurality of lenses are arranged in array, and
optical characteristics of the first lens array and the second lens array are in a predetermined relationship.

10. The apparatus according to claim 9, wherein number of lenses and positions of the lenses in the first lens array, and number of lenses and positions of the lenses in the second lens array are same.

11. The apparatus according to claim 9, wherein the illumination light from each lens of the second lens array enters a corresponding lens of the first lens array.

12. The apparatus according to claim 1, wherein an illumination condition of the illumination light includes one or more selected from an illumination angle, an illumination intensity and color tone.
